(19) United States
(12) Patent Application Publication
(10) Pub. No.: US 2009/0093281 A1
(43) Pub. Date: Apr. 9, 2009

(54) DEVICE, SYSTEM, AND METHOD OF POWER SAVING IN WIRELESS COMMUNICATION

(76) Inventors: Mustafa Demirhan, Hillsboro, OR (US); Ali Taha Koc, Hillsboro, OR (US); Rath Vannithamby, Portland, OR (US)

Correspondence Address: EMPK & SHILOH ,LLP, C/O INTELLEVATE , LLC, P.O BOX 52050, MINNEAPOLIS, MN, 55402, US

(21) Appl. No.: 11/868,501

(22) Filed: Oct. 7, 2007

(51) Int. Cl. H04B 1/38

(52) U.S. Cl. 455/574

(57) ABSTRACT

Device, system, and method of power saving in wireless communication. In some demonstrative embodiments a method may include, for example, receiving at a base station at least one uplink power saving message from at least one mobile communication device, respectively, wherein the power saving message includes battery level information and an indication of at least one power saving mechanism; and based on the battery level information and the indication, applying a selected power saving mechanism to communications between the base station and the at least one mobile communication device. Other embodiments are described and claimed

### BACKGROUND

Minimizing power consumption is an important factor in the design of wireless communication devices and/or networks in order, for example, to provide longer battery life.

One method of minimizing the power consumption in a wireless system implements switching from an active mode of operation to an idle mode of operation at a mobile communication device when there is no activity at the mobile communication device. However, when the mobile communication device is at the active mode of operation battery power consumption may be relatively high.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a wireless communication system in accordance with some demonstrative embodiments; and

FIG. 2 is a schematic flow-chart illustration of a method of power saving in wireless communication in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that embodiments of the invention may be practiced without these specific details. In other instances, well-known methods, procedures, components, units and/or circuits have not been described in detail so as not to obscure the discussion.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes. The terms “plurality” and “a plurality” as used herein includes, for example, “multiple” or “two or more”. For example, “a plurality of items” includes two or more items.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), One way and/or two-way radio communication systems, cellular radiotelephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a wired or wireless handheld device (e.g., Blackberry, Palm Treo), a Wireless Application Protocol (WAP) device, or the like. Types of WLAN and/or WMAN communication systems intended to be within the scope of the present invention include, although are not limited to, WLAN and/or WMAN communication systems as described by “IEEE-Std 802.16, 2004 Edition, Air Interface for Fixed Broadband Wireless Access Systems” standard (“the 802.16 standard”), and more particularly in “IEEE-Std 802.16e, 2005 Edition, Physical and Medium Access Control Layers for Combined Fixed and Mobile Operation in Licensed Bands”, “IEEE-Std 802.16m, Air Interface for Fixed Broadband Wireless Access Systems—Advanced Air Interface”, and the like, and/or future versions and/or derivatives and/or Long Term Evolution (LTE) of the above standards.

Some embodiments may be used in conjunction with one or more types of wireless communication signals and/or systems, for example, Radio Frequency (RE), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth, Global Positioning System (GPS), Wi-Fi, Wi-Max, ZigBee™, WiHD, Ultra-Wideband (UWB), Global System for Mobile communication (GSM), Enhanced Data CSM Environment (EDGE), 2G, 2.5G, 3G, 3.5G, or the like. Some embodiments may be used in various other devices, systems and/or networks.

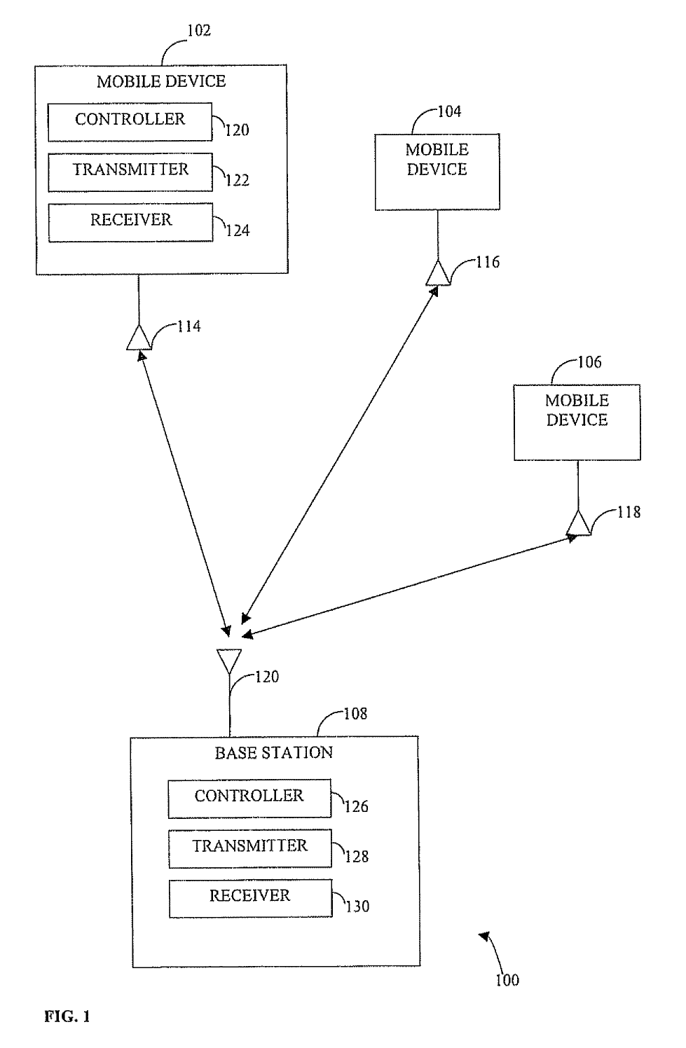

FIG. 1 schematically illustrates a block diagram of a wireless communication system 100 in accordance with some demonstrative embodiments. System 100 may include, for example, a plurality of mobile communication devices, e.g., including mobile communication devices 102, 104 and 106 capable of communicating with a Base Station (BS) 108. Devices 102, 104 and/or 106 may be or may include, for example, a mobile phone, a cellular phone, a handheld device, a computing device, a computer, a mobile computer, a portable computer, a laptop computer, a notebook computer, a tablet computer, a network of multiple inter-connected devices, a handheld computer, a handheld device, a PDA device, a handheld PDA device, a vehicular device, a non-vehicular device, a mobile or portable device, or the like. Devices 102, 104, and/or 106 may include one or more antennas 114, 116, and/or 118, respectively; and/or base station 108 may include one or more antennas 120. Although embodiments of the invention are not limited in this respect, types of antennae that may be used for antennas 114, 116, 118 and/or 120 may include but are not limited to internal antenna, dipole antenna, omni-directional antenna, a monopole antenna, an end fed antenna, a circularly polarized antenna, a micro-strip antenna, a diversity antenna and the like.

In some demonstrative embodiments, mobile devices 102, 104 and/or 106 may include a controller 120, a receiver 124, and/or a transmitter 122. For example, transmitter 122 may transmit via antenna 114 wireless RF signals, blocks, frames, transmission streams, packets, messages and/or data, e.g., to BS 108; and/or receiver 124 may receive via antenna 114 wireless RF signals, blocks, frames, transmission streams, packets, messages and/or data, e.g., from BS 108. Transmitter 122 may include, for example, any suitable RF transmitter; and/or receiver 124 may include any suitable RF receiver. Optionally, transmitter 122 and receiver 124 may be implemented using a transceiver, a transmitter-receiver, or other suitable component. In some embodiments, controller 120, transmitter 122 and/or receiver 124 may be implemented as part of a Medium Access Control (MAC) layer, a physical (PHY) layer of mobile device 102, and/or any other suitable communication layer or configuration.

In some demonstrative embodiments, at least one of mobile devices 102, 104 and 106 may transmit to BS 108 an uplink power saving message including an indication of at least one power saving mechanism, e.g., as described in detail below.

In some demonstrative embodiments, mobile device 102 may transmit an uplink power saving message to BS 108 based, for example, on a battery power level of mobile device 102. For example, mobile device 102 may transmit the uplink power saving message if the battery power level of mobile device 102 is lower than a predefined battery power level threshold.

In some demonstrative embodiments, device 102 may transmit the power saving message in association with a battery power level feedback from device 102 to BS 108. The battery power level feedback may include battery power level information corresponding to the battery power level of device 102. For example, a component of mobile device 102, e.g., controller 120, may monitor the battery power level of mobile device 102, and provide to BS 108 a feedback message, e.g., in the form of a MAC management message, relating to the battery power level of mobile device 102. The battery power level feedback may be provided by device 102 at different times. For example, the battery power level feedback may be provided periodically, e.g., mobile device 102 may periodically send current battery power level information of mobile device 102 to BS 108 as part of MAC management messages. Such periodicity may be configurable by BS 108 or through negotiation between mobile device 102 and BS 108. The periodic feedback may occur, for example, after a predefined amount of time, at set time intervals, or at differing time intervals. In some embodiments, the battery power level feedback may be event driven. For example, mobile device 102 may send the battery power level feedback when the battery power level of mobile device 102 falls below a predefined threshold, e.g., 50%, 20% and/or 10% of the available battery power.

In some demonstrative embodiments, the uplink power saving message may include a message of any suitable format and/or type. In one example, the uplink power saving message may include a MAC management message. The uplink power saving message may include, for example, information regarding at least one power saving mechanism, which may be preferred by mobile device 102.

In some demonstrative embodiments, the uplink power saving message may have the following format:

TABLE 1

| Syntax | Size | |
|---|---|---|
| Power saving-Message_Format ( ){ | | |
| Management Message Type=xx | 8 | bits |
| Preferred Power saving mechanism | Nₚₛ | bits |
| Maximum Tolerable Delay | 8 | bits |
| Maximum Tolerable Jitter | 8 | bits |
| } | | |

As shown in Table 1, the uplink power saving message may include a “type” portion including a plurality of bits, e.g., eight bits, having a value indicating that the message should be treated as a uplink power saving; and a “Preferred Power saving mechanism” portion including a plurality of Nₚₛ bits corresponding to a plurality of power saving mechanisms. For example, the “Preferred Power saving mechanism” portion of the uplink power saving message may include eight bits, having values corresponding to eight power saving mechanisms, respectively, e.g., as described below. The “Preferred Power saving mechanism” portion of the uplink power saving message may indicate at least one power saving mechanism, which may be preferred by mobile device 102, of the plurality of power saving mechanisms, e.g., as described below.

In some demonstrative embodiments, the uplink power saving message may also include one or more additional portions including information corresponding to one or more of the plurality of power saving mechanisms. For example, the uplink power saving message may include one or more threshold values corresponding to one or more of the power saving mechanisms. In one example, as shown in Table 1 the uplink power saving message may also include a “Maximum Tolerable Delay” portion including a plurality of bits, e.g., eight bits, having a value indicating a maximum delay, e.g., in terms of milliseconds, corresponding to a bandwidth aggregation mechanism, e.g., as described below; and/or a Maximum Tolerable Jitter” portion including a plurality of bits, e.g., eight bits, having a value indicating a maximum jitter, e.g., in terms of milliseconds, corresponding to the bandwidth aggregation mechanism, e.g., as described below.

In some demonstrative embodiments, the plurality of bits of the “Preferred Power saving mechanism” portion may correspond to a plurality of power saving mechanisms, respectively. For example, a first bit may correspond to a power saving mechanism including adjusting a priority scheme to be applied to communications between mobile device 102 and BS 108 (“user prioritization mechanism”); a second bit may correspond to a bandwidth aggregation for non-real-time traffic mechanism to be applied to the communications between mobile device 102 and BS 108; a third bit may correspond to a bandwidth aggregation for real-time traffic mechanism to be applied to the communications between mobile device 102 and BS 108; a fourth bit may correspond to a Connection-Identification (CID) aggregation mechanism to be applied to the communications between mobile device 102 and BS 108; a fifth bit may correspond to a Multiple-Input-Multiple-Output (MIMO) scheme to be applied to the communications between mobile device 102 and BS 108; a sixth bit may correspond to a modulation order to be applied to the communications between mobile device 102 and BS 108; a seventh bit may correspond to a Quality-of-Service (QoS) to be applied to the communications between mobile device 102 and BS 108; and/or an eight bit may correspond to a bandwidth to be allocated to the communications between mobile device 102 and BS 108, A first value, e.g., one, of a bit corresponding to a power saving mechanism may indicate the power saving mechanism is preferred by mobile device 102; and another value, e.g., zero, of the bit may indicate the power saving mechanism is not preferred by mobile device 102. For example, if only the user prioritization mechanism is preferred by mobile device 102, then the “Preferred Power saving mechanism” portion of the uplink power saving message may include the sequence of bits “10000000”.

In some demonstrative embodiments, BS 108 may be capable of receiving at least one uplink power saving message from at least one of mobile device 102, 104 and 106, respectively; and based on the at least one power saving message, applying a selected power saving mechanism to communications between BS 108 and at least one of mobile devices 102, 104 and 106, e.g., as described in detail below. For example, BS 108 may select the power saving mechanism from the predefined plurality of power saving mechanisms described above, e.g., based on any suitable criterion.

In some demonstrative embodiments, one or more elements of BS 108, e.g., controller 126, may be capable of adjusting one or more communication-configuration parameters between BS 108 and at least one of mobile devices 102, 104 and 106, e.g., based on the at least one uplink power saving message. For example, BS 108 may be capable of transmitting a downlink message to mobile device 102 based, for example, on the uplink power saving message received from mobile device 102. The Downlink message may include, for example, adjustment information corresponding to the communication-configuration parameters.

In some demonstrative embodiments, one or more elements of BS 108, e.g., controller 126, may be capable of adjusting, e.g., based on the at least one uplink power saving message, at least one of a priority scheme applied to the communications between BS 108 and at least one of mobile devices 102, 104 and 106; a bandwidth aggregation for non-real-time traffic mechanism applied to the communications BS 108 and at least one of mobile devices 102, 104 and 106; a bandwidth aggregation for real-time traffic mechanism applied to the communications BS 108 and at least one of mobile devices 102, 104 and 106; a CID aggregation mechanism applied to the communications BS 108 and at least one of mobile devices 102, 104 and 106; a MIMO output scheme applied to the communications BS 108 and at least one of mobile devices 102, 104 and 106, a modulation order applied to the communications BS 108 and at least one of mobile devices 102, 104 and 106, a QoS of the communications BS 108 and at least one of mobile devices 102, 104 and 106, and a bandwidth allocated to the communications BS 108 and at least one of mobile devices 102, 104 and 106, e.g., as described below.

In some demonstrative embodiments, one or more elements of BS 108, e.g., controller 126, may be capable of performing at least one of the following, e.g., based on an uplink power saving message received from a mobile device of system 100, e.g. device 102: increasing a priority of the mobile device, increasing a burst allocated to the mobile device, aggregating transmission frames to the mobile device, aggregating CID bursts allocated to the mobile device, decreasing a number of reception antennas implemented at the mobile device, decreasing a modulation order of a communication with the mobile device, decreasing a QoS of the communication with the mobile device, and increasing a bandwidth allocated to the communication with the mobile device.

In some demonstrative embodiments, BS 108 may receive at least one uplink power saving message from at least one mobile device (“the low power mobile device”) of system 100, e.g., device 102, having a battery power level lower than the predefined battery power level threshold, as described above.

In some demonstrative embodiments, BS 108 may be capable of adjusting a priority scheme applied to the communications between BS 108 and at least one of mobile devices 102, 104 and 106, based on the at least one uplink power saving message. The uplink power saving message may include an indication of the user prioritization mechanism, e.g., as described above. In one example, BS 108 may increase a priority of the low power mobile device, with relation to other mobile devices of system 100. The increase in the priority of the low power mobile device may allow, for example, the low power mobile device to complete downlink transmissions to BS 108 and switch to an idle mode of operation, e.g., within a relatively short time period. In one example, BS 108 may allocate the low power mobile device with transmissions closer to a DL-MAP portion of the frame, e.g., compared to other mobile devices. Accordingly, the low power mobile device may take advantage of an Inter Frame Power Saving (IFPS) mechanism and go into a semi-sleep state within the flame after completing reception.

In some demonstrative embodiments, BS 108 may be capable of adjusting a bandwidth aggregation mechanism applied to the communications between BS 108 and at least one of mobile devices 102, 104 and 106, based on the at least one uplink power saving message. In one example, BS 108 may receive, e.g., from the at least one low power mobile device, at least one uplink power saving message including an indication of at least one of the bandwidth aggregation for non-real-time traffic mechanism and the a bandwidth aggregation for real-time traffic mechanism, e.g., as described above. In one example, if the low battery mobile device is running several different applications, then BS 108 may consolidate bandwidth allocations for all the applications into as few frames as possible. For example, BS 108 may increase a burst allocated to the low power mobile device, e.g., for non-real-time traffic, for example, by allocating less frequent but bigger bursts to the low power mobile device. BS 108 may, for example, aggregate transmission frames to the low power mobile device, e.g., for real-time traffic. For example, BS 108 may aggregate the real-time traffic of multiple frames into a reduced number of frames based, for example, on the maximum tolerable delay and/or maximum tolerable jitter defined in the uplink power saving message.

In some demonstrative embodiments, BS 108 may be capable of adjusting a CID aggregation mechanism applied to the communications between BS 108 and at least one of mobile devices 102, 104 and 106, based on the at least one uplink power saving message. In one example, BS 108 may receive, e.g., from the at least one low power mobile device, at least one uplink power saving message including an indication of the CID aggregation mechanism, e.g., as described above. In one example, BS 108 may aggregate CID bursts allocated to the low power mobile device. For example, if the low power mobile device runs multiple applications with different burst profiles, then BS 108 may aggregate CIDs corresponding to the multiple applications into a common burst profile, e.g., a lowest common burst profile. As a result, a power efficiency of the low power mobile device may increase since, for example, the low power mobile device may utilize the IFPS more effectively; and/or “power consumption per bit” used by the low power mobile device may be decreased.

In some demonstrative embodiments, BS 108 may be capable of adjusting a MIMO output scheme applied to the communications between BS 108 and at least one of mobile devices 102, 104 and 106, based on the at least one uplink power saving message. In one example, BS 108 may receive, e.g., from the at least one low power mobile device, at least one uplink power saving message including an indication of the MIMO scheme, e.g., as described above. In one example, BS 108 may decrease a number of reception antennas implemented at the low power mobile device Decreasing the number of antennas implemented at the low power mobile device may not decrease a capacity linearly of the low power mobile device, while reducing the power consumption by the low power mobile device, e.g., linearly.

In some demonstrative embodiments, BS 108 may be capable of adjusting a modulation order applied to the communications between BS 108 and at least one of mobile devices 102, 104 and 106, based on the at least one uplink power saving message. In one example, BS 108 may receive, e.g., from the at least one low power mobile device, at least one uplink power saving message including an indication of the modulation order, e.g., as described above. In one example, BS 108 may decrease a modulation order of a communication with the low power mobile device. A lower order modulation order may decrease link throughput of the low power mobile device; however due to non-linear behavior, power efficiency of the low power mobile device may increase with lower order modulation schemes.

In some demonstrative embodiments, BS 108 may be capable of adjusting a QoS applied to the communications between BS 108 and at least one of mobile devices 102, 104 and 106, based on the at least one uplink power saving message. In one example, BS 108 may receive, e.g., from the at least one low power mobile device, at least one uplink power saving message including an indication of the QoS, e.g., as described above. In one example, BS 108 may decrease a QoS of the communication with the low power mobile device, e.g., while maintaining a reasonable end-to-end service quality. Decreasing the QoS may decrease the power usage significantly. In one example, transmissions between the low power mobile device and BS 108 may include video transmissions, which may be transmitted at reasonably good quality with reduced bandwidth.

In some demonstrative embodiments, BS 108 may be capable of adjusting a bandwidth allocated to the communications between BS 108 and at least one of mobile devices 102, 104 and 106, based on the at least one uplink power saving message. In one example, BS 108 may receive, e.g., from the at least one low power mobile device, at least one uplink power saving message including an indication of the bandwidth allocation, e.g., as described above. In one example, BS 108 may increase a bandwidth allocated to the low power mobile device. Allocating a wider bandwidth, e.g., for non-real-time applications, to the low power mobile device may allow the low power mobile device to complete wireless communications with BS 108 within a shorter time period, after which the low power mobile device may switch to the idle mode of operation.

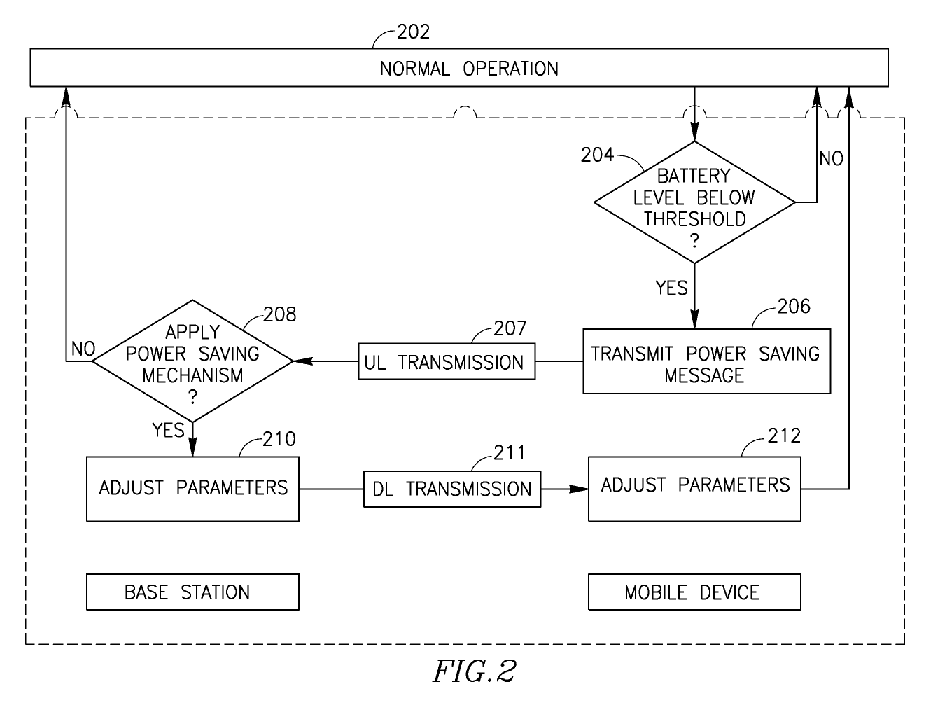

Reference is made to FIG. 2, which schematically illustrates a method of power saving in wireless communication in accordance with some demonstrative embodiments. Although embodiments of the invention are not limited in this respect, in some demonstrative embodiments one or more operation of the method of FIG. 2 may be performed by at least one mobile device, e.g., mobile device 102 (FIG. 1), and/or a BS, e.g., BS 108 (FIG. 1).

As indicated at block 202, the method may include communicating between the mobile and the BS at a normal mode of operation.

As indicated at block 204, the method may include determining whether a battery power level of the mobile device is lower than a predefined battery power level threshold. For example, mobile device 102 (FIG. 1) may check whether the battery power level of mobile device 102 (FIG. 1) is lower than a predefined battery power level threshold, e.g., as described above with reference to FIG. 1.

As indicated at block 206, the method may include transmitting an uplink power saving message from the mobile communication device to the BS, for example, if the battery power level of the mobile device is lower than the battery power level threshold. For example, device 102 (FIG. 1) may transmit to BS 108 (FIG. 1) am uplink power saving message, e.g., as described above.

As indicated at block 207, the method may also include receiving at least one uplink power saving message at the BS. The power saving message may include, for example, an indication of at least one power saving mechanism, e.g. as described above. For example, BS 108 (FIG. 1) may receive the uplink power saving message transmitted by mobile device 102 (FIG. 1).

As indicated at block 208, the method may include determining whether or not to apply a power saving mechanism to communications between the base station and the at least one mobile device. For example, BS 108 (FIG. 1) may determine whether or not to apply a power saving mechanism to communications between BS 108 (FIG. 1) and mobile device 102 (FIG. 1) based on any suitable criterion. For example, BS 108 (FIG. 1) may determine whether or not to apply a power saving mechanism to communications between BS 108 (FIG. 1) and mobile device 102 (FIG. 1) based on the battery power level feedback from mobile device 102 (FIG. 1), as described above.

As indicated at block 210 the method may include applying a selected power saving mechanism to communications between the base station and the at least one mobile device, based on the at least one uplink power saving message. For example, BS 108 (FIG. 1) may select from the predefined plurality of power saving mechanisms a power saving mechanism to be applied to communications with device 102 (FIG. 1), for example, based on the one or more power saving mechanisms indicated at the power saving message and/or the power level feedback received from mobile device 102 (FIG. 1), as described above. Applying the selected power saving mechanism may include adjusting one or more communication-configuration parameters between the base station and the at least one mobile communication device.

As indicated at block 211, the method may include transmitting a downlink message from the base station to the at least one mobile communication device, wherein the downlink message includes adjustment information corresponding to the communication-configuration parameters.

As indicate at block 212, the method may include adjusting the one or more communication-configuration parameters at the mobile device, e.g., based on the downlink message. For example, mobile device 102 (FIG. 1) may adjust the one or more communication-configuration parameters based on the downlink transmission received from BS 108 (FIG. 1).

Other suitable operations may be used, and other suitable orders of operation may be used.

Some embodiments, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid-state memory, magnetic tape, a removable computer diskette, a RAM, a ROM, a rigid magnetic disk, and an optical disk. Some demonstrative examples of optical disks include CD-ROM, CD-R/W, and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method comprising:
receiving at a base station at least one uplink power saving message from at least one mobile communication device, respectively, wherein said power saving message includes battery level information and an indication of at least one power saving mechanism; and
based on said battery level information and said indication, applying a selected power saving mechanism to communications between said base station and said at least one mobile communication device.

2. The method of claim 1, wherein applying the selected power saving mechanism comprises adjusting one or more communication-configuration parameters between said base station and said at least one mobile communication device.

3. The method of claim 2, wherein adjusting said communication-configuration parameters comprises transmitting a downlink message from said base station to said at least one mobile communication device, wherein said downlink message includes adjustment information corresponding to said communication-configuration parameters.

4. The method of claim 2, wherein adjusting said communication configuration parameters comprises adjusting at least one of a priority scheme applied to said communications, a bandwidth aggregation for non-real-time traffic mechanism applied to said communications, a bandwidth aggregation for real-time traffic mechanism applied to said communications, a connection-identification aggregation mechanism applied to said communications, a multiple-input-multiple output scheme applied to said communications, a modulation order applied to said communications, a quality-of-service of said communications, and a bandwidth allocated to said communications.

5. The method of claim 2, wherein adjusting said communication configuration parameters comprises at least one of increasing a priority of said mobile communication device, increasing a burst allocated to said mobile communication device, aggregating transmission frames to said mobile communication device, aggregating connection-identification bursts allocated to said mobile communication device, decrease a number of reception antennas implemented at said mobile communication device, decreasing a modulation order of a communication with said mobile communication device, decreasing a quality-of-service of the communication with said mobile communication device, and increasing a bandwidth allocated to the communication with said mobile communication device.

6. The method of claim 1 comprising transmitting said uplink power saving message from said mobile communication device if a battery power level of said mobile communication device is lower than a battery power level threshold.

7. The method of claim 1, wherein said uplink power saving message comprises one or more threshold values corresponding to said power saving mechanism.

8. The method of claim 7, wherein said one or more threshold values comprise at least one of a delay threshold value and a jitter threshold value.

9. A base station capable of receiving from at least one mobile communication device at least one uplink power saving message including battery level information and an indication of at least one power saving mechanism; and, based on said battery level information and said indication, applying a selected power saving mechanism to communications between said base station and said mobile communication device.

10. The base station of claim 9, wherein said base station is capable of adjusting one or more communication configuration parameters between said base station and said at least one mobile communication device.

11. The base station of claim 10, wherein base station is capable of transmitting a downlink message to said at least one mobile communication device, wherein said downlink message includes an indication of said communication configuration parameters.

12. The base station of claim 10, wherein said base station is capable of adjusting at least one of a priority scheme applied to said communications, a bandwidth aggregation for non-real-time traffic mechanism applied to said communications, a bandwidth aggregation for real-time traffic mechanism applied to said communications, a connection-identification aggregation mechanism applied to said communications, a multiple-input-multiple output scheme applied to said communications, a modulation order of said communications, a quality-of-service of said communications, and a bandwidth allocated to said communications.

13. The base station of claim 9, wherein said battery level information indicates a battery power level of said mobile communication device is lower than a battery power level threshold.

14. The base station of claim 9, wherein said uplink power saving message comprises one or more threshold values corresponding to said power saving mechanism.

15. The base station of claim 14, wherein said one or more threshold values comprise at least one of a delay threshold value and a jitter threshold value.
